(19) United States
(12) Patent Application Publication
(10) Pub. No.: US 2026/0292883 A1
(43) Pub. Date: Sep. 24, 2026

(54) POWER CONTROL FOR PRACH REPETITION OVER DIFFERENT SLOT TYPES

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed IBRAHIM, San Diego, CA (US)

(21) Appl. No.: 19/084,537

(22) Filed: Mar. 19, 2025

(51) Int. Cl. H04W 74/0833; H04W 52/36

(52) U.S. Cl. CPC H04W 74/0833; H04W 52/36

(57) ABSTRACT

A method for wireless communication at a user equipment (UE) and related apparatus are provided. In the method, the UE obtains an indication of power information for a plurality of physical random access channel (PRACH) transmissions via a set of slots. The power information indicates the transmission power for each PRACH transmission of the plurality of PRACH transmissions. The UE further configures the slot power for at least one slot of the set of slots based on the transmission power for each PRACH transmission of the plurality of PRACH transmissions, and transmits, via the at least one slot of the set of slots, at least one PRACH transmission of the plurality of PRACH transmissions based on the slot power.

### TECHNICAL FIELD

The present disclosure relates generally to communication systems and, more particularly, to power control in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology and future wireless communication technologies. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to obtain an indication of power information for a plurality of physical random access channel (PRACH) transmissions via a set of slots, where the power information indicates a transmission power for each PRACH transmission of the plurality of PRACH transmissions; configure, based on the transmission power for each PRACH transmission of the plurality of PRACH transmissions, a slot power for at least one slot of the set of slots; and transmit, via the at least one slot of the set of slots, at least one PRACH transmission of the plurality of PRACH transmissions based on the slot power.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to transmit, to a user equipment (UE), an indication of power information for a plurality of PRACH transmissions via a set of slots, where the power information indicates a transmission power for each PRACH transmission of the plurality of PRACH transmissions; and receive, from the UE, via at least one slot of the set of slots, at least one PRACH transmission of the plurality of PRACH transmissions based on a slot power for the at least one slot of the set of slots. The slot power is based on the transmission power for each PRACH transmission of the plurality of PRACH transmissions.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A and FIG. 4B illustrate example aspects of random access procedures.

FIG. 5 is a diagram illustrating an example random access occasion (RO) group for the physical random access channel (PRACH) repetition.

FIG. 6 is a diagram illustrating an example subband full duplex (SBFD) operation.

FIG. 7 shows diagrams illustrating the examples of the power control under different combinations of slot types.

FIG. 8 shows diagrams illustrating example power control methods in accordance with various aspects of the present disclosure.

FIG. 9 is a diagram illustrating an example power control method in accordance with various aspects of the present disclosure.

FIG. 10 is a call flow diagram illustrating a method of wireless communication in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a network entity in accordance with various aspects of the present disclosure.

FIG. 14 is a flowchart illustrating methods of wireless communication at a network entity in accordance with various aspects of the present disclosure.

FIG. 15 is a diagram illustrating an example of a hardware implementation for an example apparatus and/or UE.

FIG. 16 is a diagram illustrating an example of a hardware implementation for an example network entity.

### DETAILED DESCRIPTION

In wireless communication, a user equipment (UE) may initiate communication with a network using a physical random access channel (PRACH) transmission (e.g., a PRACH preamble transmission). To improve the likelihood of successful reception by the network, the UE may repeat the PRACH transmission multiple times, a process referred to as PRACH repetition. The UE may repeat the PRACH transmissions on different slot types, with each slot type associated with different power control settings. Example aspects presented herein provide a unified power control mechanism for optimizing PRACH repetition transmission power in a wireless network, such as a 6G network.

Various aspects relate generally to wireless communication. Some aspects more specifically relate to power control for PRACH repetition over different slot types. In some examples, a UE may obtain an indication of power information for a plurality of PRACH transmissions via a set of slots. The power information may indicate the transmission power for each PRACH transmission of the plurality of PRACH transmissions. Based on the transmission power for each PRACH transmission of the plurality of PRACH transmissions, the UE may configure a slot power for at least one slot of the set of slots, and transmit, via the at least one slot of the set of slots, at least one PRACH transmission of the plurality of PRACH transmissions based on the slot power. In some examples, the plurality of PRACH transmissions may include a plurality of PRACH repetitions on PRACH occasions located on the set of slots. In some examples, the set of slots may include a first set of time division duplexing (TDD) slots or a second set of subband full-duplex (SBFD) slots, and the power information may include a target reception power and a power ramping step. The UE may configure the slot power for the at least one slot of the set of slots based on the target reception power and the power ramping step. In some examples, the set of slots may include at least one TDD slot and at least one SBFD slot, and the UE may configure a first slot power for one of the TDD slot or the SBFD slot; and obtain a second slot power for another one of the TDD slot or the SBFD slot based on the first slot power and a power offset. In some examples, the UE may determine the total transmission power for the plurality of PRACH transmissions via the set of slots, and the UE may further redistribute the total transmission power over the set of slots to obtain the slot power for the at least one slot of the set of slots.

Particular aspects of the subject matter described in this disclosure can be implemented to realize one or more of the following potential advantages. In some examples, by providing a unified power control mechanism for PRACH repetition transmission that accounts for the composition of slot types within a repetition, the described techniques improve random access performance and enhance resource utilization efficiency. In some examples, by determining PRACH transmission power based on whether the PRACH repetitions occur entirely on TDD slots, entirely on SBFD slots, or a combination of both, the described techniques enable power control strategies tailored to the specific slot composition, thereby avoiding over-powering or under-powering individual repetitions. In some examples, by calculating the total transmission power over all PRACH repetitions and redistributing it among the different slot types, the described techniques ensure consistent overall power output while optimizing power balance between slot types.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

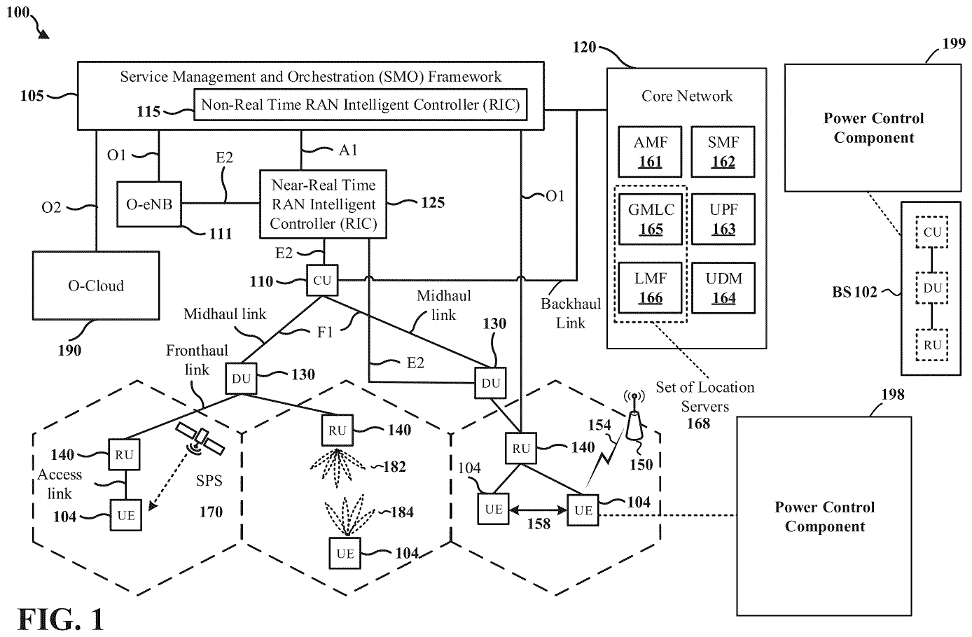

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the power control component 198. The power control component 198 may be configured to obtain an indication of power information for a plurality of PRACH transmissions via a set of slots, where the power information indicates a transmission power for each PRACH transmission of the plurality of PRACH transmissions; configure, based on the transmission power for each PRACH transmission of the plurality of PRACH transmissions, a slot power for at least one slot of the set of slots; and transmit, via the at least one slot of the set of slots, at least one PRACH transmission of the plurality of PRACH transmissions based on the slot power. In certain aspects, the base station 102 may include the power control component 199. The power control component 199 may be configured to transmit, to a UE, an indication of power information for a plurality of PRACH transmissions via a set of slots, where the power information indicates a transmission power for each PRACH transmission of the plurality of PRACH transmissions; and receive, from the UE, via at least one slot of the set of slots, at least one PRACH transmission of the plurality of PRACH transmissions based on a slot power for the at least one slot of the set of slots, where the slot power is based on the transmission power for each PRACH transmission of the plurality of PRACH transmissions. Although the following description may be focused on 5G NR, the concepts described herein may be applicable to other similar areas, such as LTE, LTE-A, CDMA, GSM, and other wireless technologies.

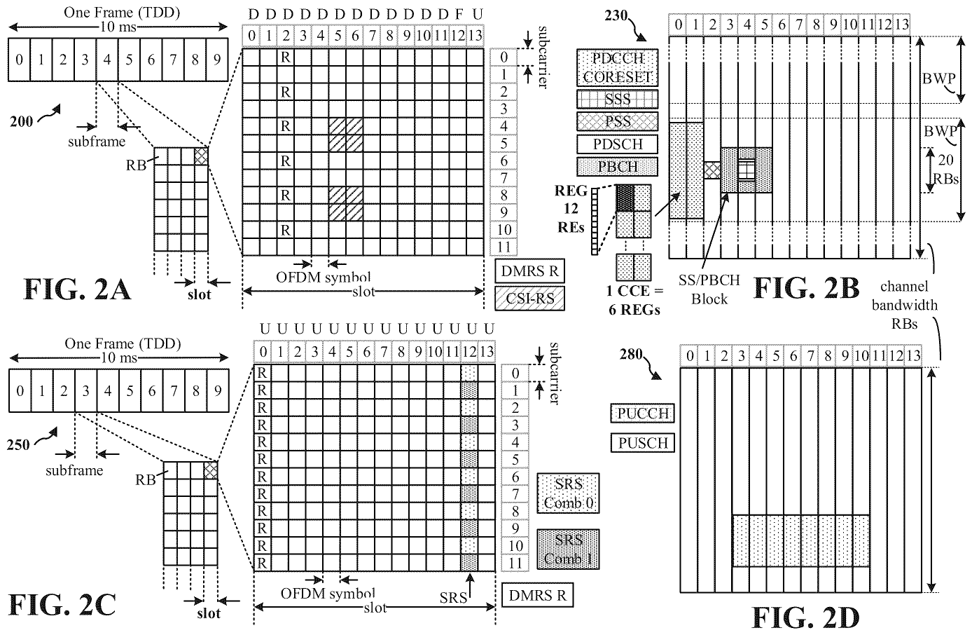

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 24*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

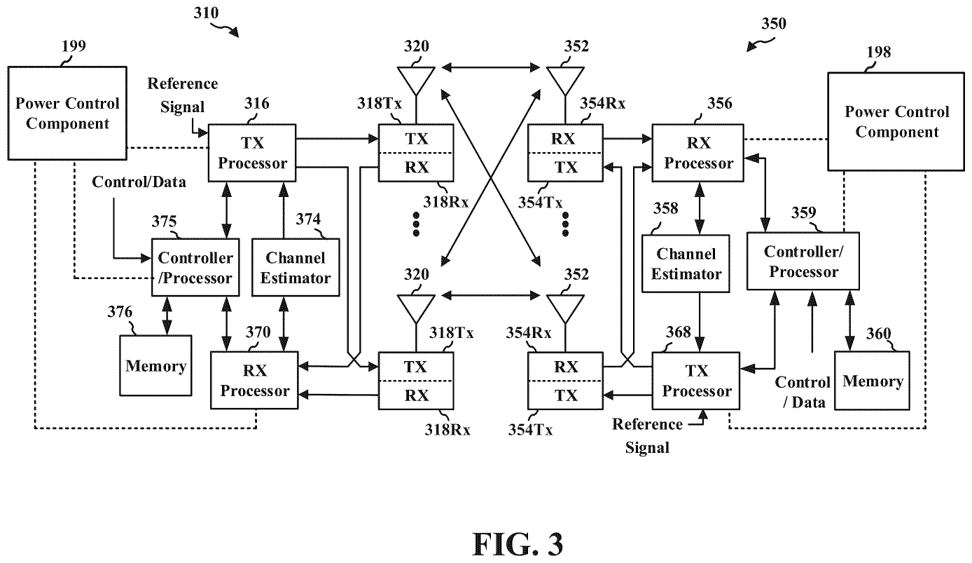

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the power control component 198 of FIG. 1.

At least one of the TX processor 316, the RX processor 370, and the controller/processor 375 may be configured to perform aspects in connection with the power control component 199 of FIG. 1.

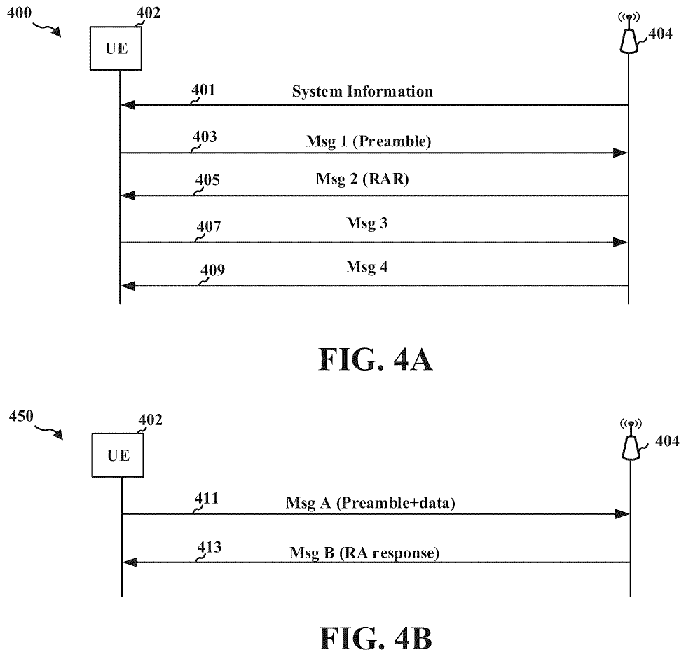

A UE may use a random access procedure in order to communicate with a base station. For example, the UE may use the random access procedure to request an RRC connection, to re-establish an RRC connection, to resume an RRC connection, etc. FIG. 4A illustrates example aspects of a random access procedure 400 between a UE 402 and a base station 404. The UE 402 may initiate the random access message exchange by sending to the base station 404 a first random access message 403 (e.g., message (Msg) 1) including a preamble. Prior to sending the first random access message 403, the UE 402 may obtain random access parameters, e.g., including preamble format parameters, time and frequency resources, parameters for determining root sequences and/or cyclic shifts for a random access preamble, etc., e.g., in system information 401 from the base station 404. The preamble may be transmitted with an identifier, such as a Random Access RNTI (RA-RNTI). The UE 402 may select a random access preamble sequence, e.g., from a set of preamble sequences. If the UE 402 selects the preamble sequence, the base station 404 may receive another preamble from a different UE at the same time. In some examples, a preamble sequence may be assigned to the UE 402.

The base station responds to the first random access message 403 by sending a second random access message 405 (e.g., Msg 2) using PDSCH and including a random access response (RAR). The RAR may include, e.g., an identifier of the random access preamble sent by the UE, a timing advance (TA), an uplink grant for the UE to transmit data, a cell radio network temporary identifier (C-RNTI) or other identifier, and/or a back-off indicator. Upon receiving the RAR at 405, the UE 402 may transmit a third random access message 407 (e.g., Msg 3) to the base station 404, e.g., using PUSCH, that may include an RRC connection request, an RRC connection re-establishment request, or an RRC connection resume request, depending on the trigger for the initiating the random access procedure. The base station 404 may then complete the random access procedure by sending a fourth random access message 409 (e.g., Msg 4) to the UE 402, e.g., using PDCCH for scheduling and PDSCH for the message. The fourth random access message 409 may include a random access response message that includes timing advancement information, contention resolution information, and/or RRC connection setup information. The UE 402 may monitor for PDCCH, e.g., with the C-RNTI. If the PDCCH is successfully decoded, the UE 402 may also decode PDSCH. The UE 402 may send HARQ feedback for any data carried in the fourth random access message. If two UEs send the same preamble at 403, both UEs may receive the RAR leading both UEs to send a third random access message 407. The base station 404 may resolve such a collision by being able to decode the third random access message from one of the UEs and responding with a fourth random access message to that UE. The other UE, which did not receive the fourth random access message 409, may determine that random access did not succeed and may re-attempt random access. Thus, the fourth message may be referred to as a contention resolution message. The fourth random access message 409 may complete the random access procedure. Thus, the UE 402 may then transmit uplink communication and/or receive downlink communication with the base station 404 based on the RAR.

In order to reduce latency or control signaling overhead, a single round trip cycle between the UE and the base station 404 may be achieved in a 2-step RACH process 450, such as shown in FIG. 4B. Aspects of Msg 1 and Msg 3 may be combined in a single message, e.g., which may be referred to as Msg A. The Msg A may include a random access preamble, and may also include a PUSCH transmission, e.g., such as data. The MsgA preambles may be separate from the four step preambles, yet may be transmitted in the same random access occasions (ROs) as the preambles of the four step RACH procedure or may be transmitted in separate ROs. The PUSCH transmissions may be transmitted in PUSCH occasions (POs) that may span multiple symbols and PRBs. After the UE 402 transmits the Msg A 411, the UE 402 may wait for a response from the base station 404. Additionally, aspects of the Msg 2 and Msg 4 may be combined into a single message, which may be referred to as Msg B. Two step RACH may be triggered for reasons similar to a four-step RACH procedure. If the UE does not receive a response, the UE may retransmit the MsgA or may fall back to a four-step RACH procedure starting with a Msg 1. If the base station detects the Msg A, but fails to successfully decode the Msg A PUSCH, the base station may respond with an allocation of resources for an uplink retransmission of the PUSCH. The UE may fall back to the four step RACH with a transmission of Msg 3 based on the response from the base station and may retransmit the PUSCH from Msg A. If the base station successfully decodes the Msg A and corresponding PUSCH, the base station may reply with an indication of the successful receipt, e.g., as a random access response 413 that completes the two-step RACH procedure. The Msg B may include the random access response and a contention-resolution message. The contention resolution message may be sent after the base station successfully decodes the PUSCH transmission.

In wireless communication, a UE may initiate communication with a network (e.g., a base station) by sending a preamble message on a physical random access channel (PRACH) (e.g., in a first random access message such as a Msg 1 in FIG. 4A or Msg A in FIG. 4B). In situations where the network conditions are challenging, such as when the signal strength (e.g., the reference signal received power (RSRP) of the signal) is low or the interference is high, the UE may repeat the transmission of the preamble message multiple times, a process that may be referred to as “PRACH repetition,” to improve the coverage and the reliability of the PRACH access attempts. As an example, a number of

$${N}_{preamble}^{rep} > 1$$

preamble repetitions for the PRACH transmissions may be transmitted if the UE would transmit the PRACH with repetitions. For a PRACH transmission with

$${N}_{preamble}^{rep}$$

preamble repetitions, a set consists of

$${N}_{preamble}^{rep}$$

valid random access occasions (ROs) may be used for the PRACH repetitions. These ROs may be consecutive in time, use the same frequency resources, and are associated with the same synchronization signal block (SSB). The UE then may use those ROs for a number of repetitions. In some aspects, the number of repetitions may be specified.

In some examples, the PRACH repetitions may be performed on a group of ROs (or an RO group) that may include a set of

$${N}_{preamble}^{rep}$$

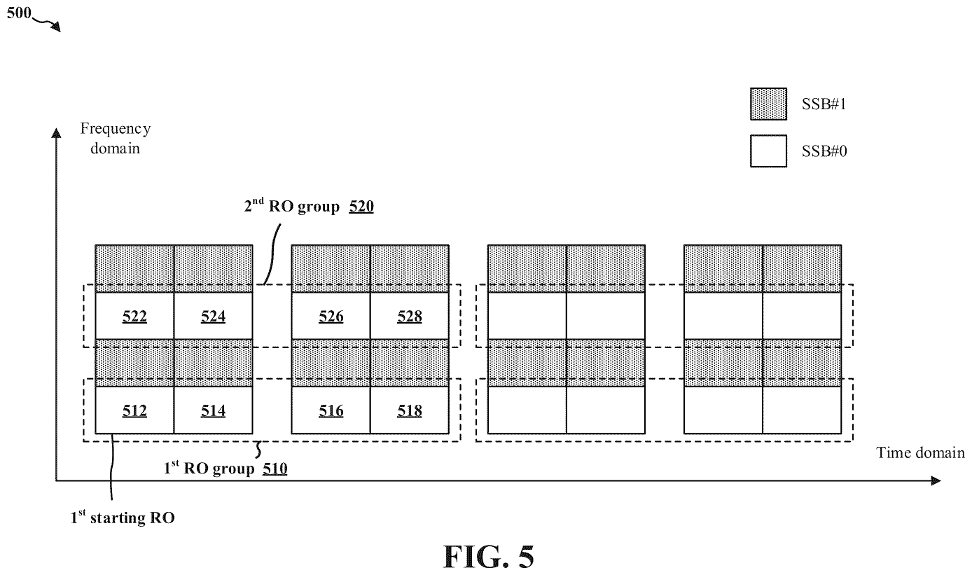

valid PRACH occasions. These PRACH occasions may be consecutive in time and use the same frequency resources. FIG. 5 is a diagram 500 illustrating an example RO group for the PRACH repetition. For example, as shown in FIG. 5, the first RO group 510 may include ROs 512, 514, 516, 518 that are consecutive in time and use the same frequency resources. The second RO group 520 may include ROs 522, 524, 526, 528 that are consecutive in time and use the same frequency resources. All the ROs in an RO group may correspond to the same SSB. The RO groups (e.g., the first RO group 510 and the second RO group 520) in FIG. 5 are for four PRACH repetitions. Hence, each RO group may include four frequency division multiplexed (FDMed) ROs. For example, the first RO group 510 may include ROs 512, 514, 516, 518.

In some examples, wireless communication systems may be configured to share available system resources and provide various telecommunication services (e.g., telephony, video, data, messaging, broadcasts, etc.) based on multiple-access technologies that support communication with multiple users. Full duplex operation, in which a wireless device exchanges uplink and downlink communication that overlaps in time, may enable more efficient use of the wireless spectrum. Full duplex operation may include simultaneous transmission and reception in the same frequency range. In some examples, the frequency range may be an mmW frequency range, e.g., frequency range 2 (FR2). In some examples, the frequency range may be a sub-6 GHz frequency range, e.g., frequency range 1 (FR1). Full duplex communication may reduce latency. As one example, full duplex operation may enable a base station to transmit a downlink signal in an uplink-only slot, which can reduce the latency for the downlink communication. Full duplex communication may improve spectrum efficiency, e.g., spectrum efficiency per cell or per UE. Full duplex communication may enable more efficient use of wireless resources.

There may be various modes of full duplex communication. In some aspects, a first base station may transmit and receive full duplex communication with a first UE and a second UE that transmit or receive half-duplex communication in a half-duplex mode. In some aspects, a base station may transmit and receive full-duplex communication with a UE that operates in a full-duplex mode.

Full duplex communication may be in the same frequency band. The uplink and downlink communication may be in different frequency subbands, in the same frequency subband, or in partially overlapping frequency subbands.

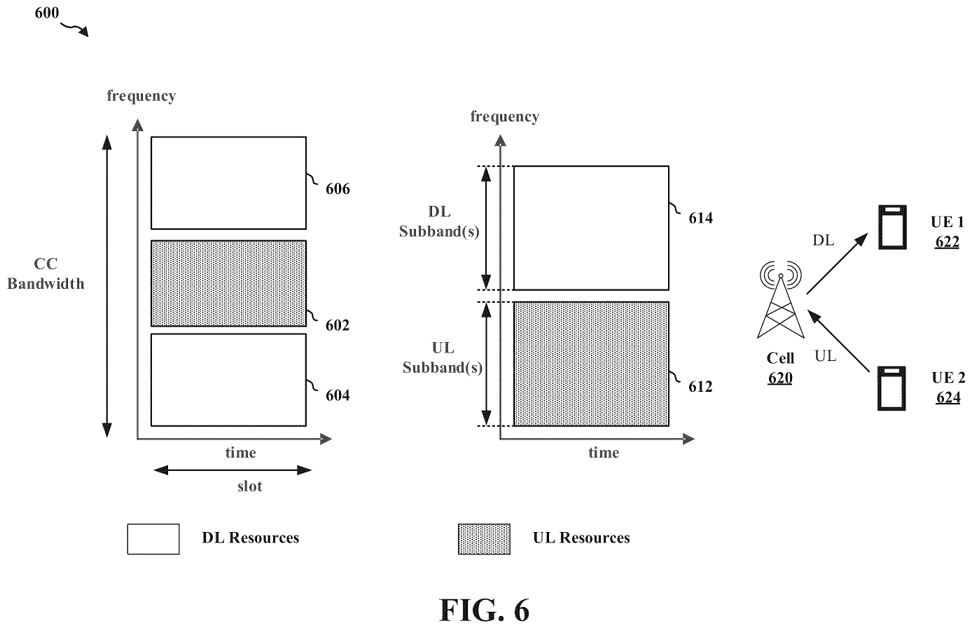

FIG. 6 is a diagram 600 illustrating an example subband full duplex (SBFD) operation. As shown in FIG. 6, a cell 620 may have downlink communication with one UE (e.g., UE 1 622), and simultaneously have uplink communication with another UE (e.g., UE 2 624) on the same slot. In one example, the downlink communication with UE 1 622 may utilize downlink resources 604, 606, and the uplink communication with UE 2 624 may utilize uplink resources 602. In another example, the downlink communication with UE 1 622 may utilize downlink resources 614, and the uplink communication with UE 2 624 may utilize uplink resources 612.

In some examples, SBFD-aware UEs (e.g., UE 1 622, UE 2 624) in the RRC CONNECTED state may use the SBFD symbols for PRACH transmissions. As used herein, an SBFD-aware UE may be a UE that is capable of recognizing and operating with SBFD configurations. In some examples, for random access operations involving SBFD-aware UEs (e.g., UE 1 622, UE 2 624) in the RRC CONNECTED state, a single RACH configuration may be provided, which may apply to all symbol types, with the ROs within the uplink subband (e.g., uplink resources 602, 612) in SBFD symbols may be valid for an SBFD-aware UE. In some examples, two separate RACH configurations may be used, including one RACH configuration for time domain multiplexing (TDD) resources (e.g., TDD symbols) and one additional RACH configuration for SBFD resources (e.g., SBFD symbols). In this case, the ROs within the uplink subband (e.g., uplink resources 602, 612) in SBFD symbols configured by the additional RACH configuration may be valid for an SBFD-aware UE. Table 2 shows the example RACH configurations for different symbol types.

TABLE 2
The example RACH configurations for different symbol types

| | | Separated RACH |
|---|---|---|
| | | configurations for each |
| | One RACH configuration for all | duplex type (e.g., TDD and |
| | symbol types | SBFD) |
| Benefits | Single configuration, no extra | Separate RACH |
| | signaling | configuration can have its |
| | Non SBFD-aware UE may leverage | own parameters (RO |
| | RA in SBFD symbols if ROs | time/frequency resources |
| | configured in SBFD-FL | and/or power |
| | | configuration). |
| | | Independent SSB-RO |
| | | mapping |
| Limitations | SSB-RO mapping ambiguity | Extra |
| | between regular UE and SBFD- | configurations/overhead |
| | aware UE. | SBFD ROs just applicable |
| | When the UL-SB in middle, the | for SBFD-aware UEs |
| | PRACH frequency resource may | |
| | cause resource fragmentation in | |
| | uplink slots. | |
| Specification | Enhancement to indicate SBFD- | For SBFD-aware UE, |
| Impact | ROs | define RO validity rules in |
| | For SBFD-aware UE, define RO | SBFD-DL symbols by |
| | validity rules in SBFD-DL symbols | TDD-UL-UL. |
| | by TDD-DL-UL | SBFD-aware UE selection |
| | SSB-ROs mapping | of ROs configuration and |
| | | switching between RO- |
| | | configurations. |

In some examples, the PRACH repetition may not span across different slot types. For example, when a UE repeats the PRACH transmission, it may use TDD ROS or SBFD ROs to form a repetition group (e.g., the first RO group 510 or the second RO group 520), but not both. This limitation may be due to, for example, factors such as separate configurations, different SSB-RO mappings, or the existence of UEs that are not aware of SBFD ROs.

With the advancement in wireless communication techniques, such as the evolution toward 6G networks, a single configuration may be used to support both TDD and SBFD slots, with all UEs aware of the different slot types. On the other hand, enabling PRACH repetition across different slot types introduces challenges, such as power control across different slot types. In some examples, PRACH repetitions over TDD slots and SBFD slots may have different power control parameters or settings due to inherent differences in transmission characteristics between the two slot types. When a single configuration is used for different slot types (e.g., TDD and SBFD slots), the power control mechanism for the PRACH repetition may be adapted accordingly. Example aspects presented herein present a unified power control mechanism for optimizing PRACH repetition transmission power in wireless networks (e.g., 6G networks) by calculating transmission power for different slot types with offsets for SBFD and TDD random access opportunities (ROSs) or RACH occasions (ROs) and redistributing total transmission power across these opportunities or occasions, ensuring balanced power allocations across SBFD and TDD slots.

In some aspects, when there is a power difference across PRACH occasions within the same repetition group, the network may be notified of this difference either during the first transmission or a retransmission. Additionally, power control may be adjusted based on the various combinations of different slot types (e.g., different numbers of ROs in SBFD and TDD slots) for PRACH repetition. For example, in one scenario, a UE may transmit four repetitions across three TDD ROs and one SBFD RO. In another scenario, the UE may transmit four repetitions across one TDD RO and three SBFD ROs. Without accounting for the different combinations of slot types, the UE may inadvertently transmit with excessively high power in an SBFD slot or insufficient power in a TDD slot.

In some aspects, all these combinations of the repetitions may be governed by the total transmission power, regardless of the distribution of different slot types, and the UE may adjust the transmission power for each slot type based on the total transmission power. For example, if the UE transmits in three SBFD ROs, it may reduce the transmission power for the SBFD ROs and increase the power for the TDD RO to balance the overall transmission power. Some example aspects presented herein provide an uplink power control mechanism for PRACH repetition spanning different slot types, in which the transmission power is determined based on the number of SBFD ROs and TDD ROs within a repetition.

In some examples, a UE may determine the transmission power for a PRACH transmission, P_{PRACH,b,f,c}(i), on active uplink BWP b of carrier f of serving cell c based on downlink reference signal for serving cell c in transmission occasion i as:

$${P}_{PRACH , b , f , c} ( i ) = min \{ {P}_{CMAX , f , c} ( i ) , {P}_{PRACH , target , f , c} + {PL}_{b , f , c} \} [ dBm ] \qquad ( 1 )$$

where P_{CMAX,f,c}(i) is the UE configured maximum output power for carrier f of serving cell c within transmission occasion i. P_{PRACH,target,f,c} is the PRACH target reception power PREAMBLE_RECEIVED_TARGET_POWER, which may be provided by higher layers for the active uplink BWP b of carrier f of serving cell c. PL_{b,f,c} is a pathloss for the active uplink BWP b of carrier f. In some examples, the PRACH target reception power (e.g., PREAMBLE_RECEIVED_TARGET_POWER) may be set based on a preamble received target power (e.g., preambleReceivedTargetPower), a power variation associated with the preamble (e.g., DELTA_PREAMBLE), a power ramping counter associated with the preamble (e.g., PREAMBLE_POWER_RAMPING_COUNTER), a preamble power ramping step (e.g., PREAMBLE_POWER_RAMPING_STEP), and a step for power offset for the random access procedure (e.g., POWER_OFFSET_2STEP_RA).

In some aspects, the PRACH transmission power over repetition may be determined according to different combination of the slot types (e.g., different combination of TDD slots and SBFD slots). In some examples, when all ROs of the PRACH repetition are on TDD slots, the PRACH transmission power may be determined based on TDD values for the preamble received target power (e.g., preambleReceivedTargetPower) and the preamble power ramping step (e.g., PREAMBLE_POWER_RAMPING_STEP). In some examples, when all ROs of the PRACH repetition are on SBFD slots, the PRACH transmission power may be determined based on SBFD values for the preamble received target power (e.g., preambleReceivedTargetPower) and the preamble power ramping step (e.g., PREAMBLE_POWER_RAMPING_STEP).

In some examples, when the ROs of the PRACH repetition are on a combination of TDD slot and SBFD slot, power control (e.g., the transmission power for PRACH repetition) may be calculated for one of the TDD ROS or SBFD ROs, and an offset may be applied to obtain the power control (e.g., the transmission power for PRACH repetition) for the other one of the TDD ROS or SBFD ROs. That is, power control (e.g., the transmission power for PRACH repetition) for a reference slot, which may be one of TDD slot or SBFD slot, may first be obtained. Based on that, the power control (e.g., the transmission power for PRACH repetition) for the other one of the TDD slot or SBFD slot may be obtained.

In some aspects, the power control of a reference slot (e.g., one of TDD slot or SBFD slot) may be obtained in different ways. In one configuration, the power control of a reference slot (e.g., one of TDD slot or SBFD slot) may be obtained based on a semi-static configuration (e.g., a semi-static configuration from the base station). For example, the semi-static configuration may provide the proper parameter values for the preamble received target power (e.g., preambleReceivedTargetPower), the power variation associated with the preamble (e.g., DELTA_PREAMBLE), or both, for each combination of different slot types. For example, one set of parameter values may be used for a combination of one TDD slot and three SBFD slots, and another set of parameter values may be used for a combination of two TDD slots and two SBFD slots. The power control of a reference slot (e.g., one of TDD slot or SBFD slot) may be obtained based on the parameter values provided in the semi-static configuration.

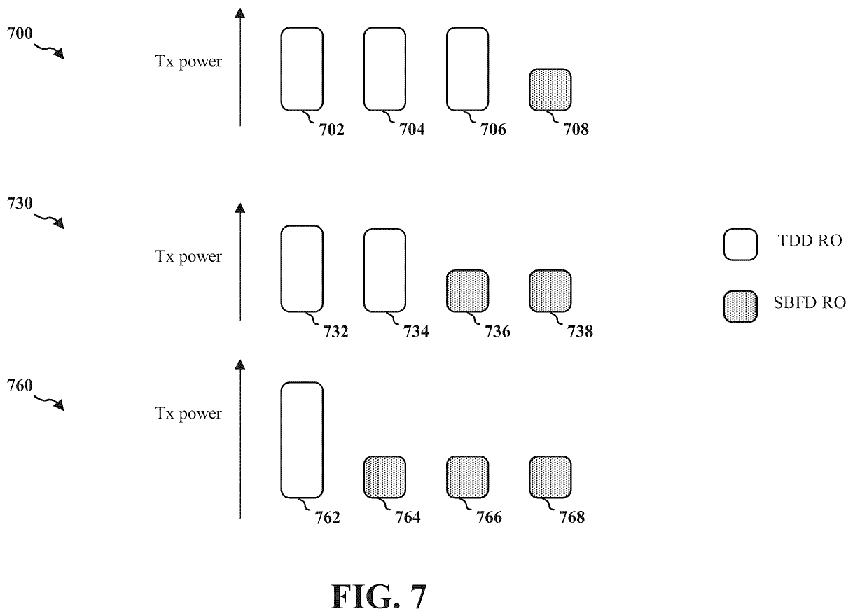

FIG. 7 shows diagrams illustrating the examples of the power control under different combinations of slot types. As shown in FIG. 7, in diagram 700, the PRACH repetition may be transmitted on a first combination of three TDD ROs (e.g., RO 702, 704, 706) and one SBFD RO (e.g., RO 708). In diagram 730, the PRACH repetition may be transmitted on a second combination of two TDD ROs (e.g., RO 732, 734) and two SBFD ROs (e.g., RO 736, 738). In diagram 760, the PRACH repetition may be transmitted on a third combination of one TDD RO (e.g., RO 762) and three SBFD ROs (e.g., RO 764, 766, 768). In some examples, a semi-static configuration may provide the proper parameter values (e.g., preambleReceivedTargetPower and DELTA_PREAMBLE), for each of the first combination, the second combination, and the third combination.

In another configuration, the power control of a reference slot (e.g., one of TDD slot or SBFD slot) may be obtained based on one semi-static configuration (e.g., a semi-static configuration from the base station) and an offset, which may be applied based on the decomposition of the different slot types. In one example, the power control of a reference slot (e.g., one of TDD slot or SBFD slot) may be obtained based on one value of the preamble received target power (e.g., preambleReceivedTargetPower) and an offset multiplied by the number of SBFD ROs. For example, referring to diagram 700 in FIG. 7, the power control of a reference slot (e.g., one of TDD slot or SBFD slot) may be obtained based on one value of the preamble received target power (e.g., preambleReceivedTargetPower) and an offset multiplied by the number of SBFD ROs (e.g., 1).

In another example, the power control of a reference slot (e.g., one of TDD slot or SBFD slot) may be obtained based on one value of the preamble received target power (e.g., preambleReceivedTargetPower) and an offset. The value of the offset may be based on the number of SBFD ROs in the PRACH repetition. For example, in FIG. 7, the offset for one SBFD RO (e.g., in diagram 700), two SBFD ROs (e.g., in diagram 730), and three SBFD ROs (e.g., in diagram 760) may each have distinct values, which may differ from one another. In some examples, the offset values for different numbers of SBFD ROs may not be linear with respect to the number of SBFD ROs.

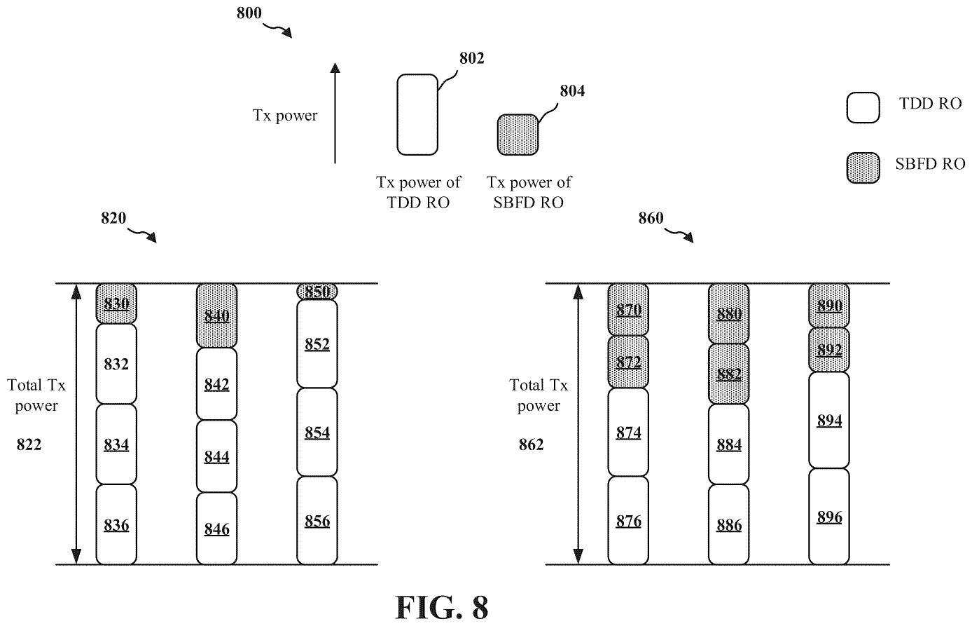

In some aspects, the power control method for the PRACH repetition may be performed in multiple steps based on a total transmission power. In the first step, the UE may determine the transmission power over each RO. In this step, the UE may determine different transmission powers for different slot type (or RO type), such as the TDD RO or the SBFD RO. FIG. 8 shows diagrams illustrating example power control methods in accordance with various aspects of the present disclosure. As shown in FIG. 8, in diagram 800, the UE may first determine the first transmission power 802 for TDD RO and the second transmission power 804 for SBFD RO.

In the second step, the UE may calculate the total transmission power over all PRACH repetitions. For example, referring to FIG. 8, in diagram 820, the UE may calculate the total transmission power 822 for the combination of three TDD ROS (e.g., transmission power 832, 834, 836) and one SBFD RO (e.g., transmission power 830). In diagram 860, the UE may calculate the total transmission power 862 for the combination of two TDD ROs (e.g., transmission power 874, 876) and two SBFD ROs (e.g., transmission power 870, 872).

In the third step, the UE may redistribute the total transmission power over the ROs. For example, referring to FIG. 8, in diagram 820, the UE may redistribute the total transmission power 822 over the three TDD ROs and one SBFD RO. In diagram 860, the UE may redistribute the total transmission power 862 over the two TDD ROs and two SBFD ROs.

In some examples, the redistribution of the total transmission power may be implemented in different ways. In one configuration, the total transmission power may be distributed equally across all ROs regardless of the RO type (e.g., SBFD slot or TDD slot). For example, referring to FIG. 8, in diagram 820, the total transmission power 822 may be distributed equally across all ROs into transmission power 840, 842, 844, 846, respectively corresponding to the four ROs, regardless of the RO type. In diagram 860, the total transmission power 862 may be distributed equally across all ROs into transmission power 880, 882, 884, 886, respectively corresponding to the four ROs, regardless of the RO type.

In another configuration, when redistributing the total transmission power across different RO type (or slot type), more power may be given to one slot type, such as the TDD slot, and less power may be given to another slot type (e.g., SBFD slot) so that the total transmission power may remain the same. In this case, the power may be distributed based on a distribution weight, which is a ratio of the transmission power allocated to one slot type (e.g., TDD slot) to the total transmission power.

For example, referring to FIG. 8, in diagram 820, when redistributing the total transmission power 822 across different RO type, more power may be given to the TDD RO (e.g., transmission power 852, 854, 856), and less power (e.g., transmission power 850) may be given to SBFD RO, so that the total transmission power may remain the same. In diagram 860, when redistributing the total transmission power 862 across different RO type, more power may be given to the TDD RO (e.g., transmission power 894, 896), and less power (e.g., transmission power 890, 892) may be given to SBFD RO, so that the total transmission power may remain the same.

In some examples, the distribution weight may be semi-statically configured to the UE. In yet another configuration, the total transmission power may be redistributed across the ROs such that the transmission power allocated to one slot type or RO type (e.g., TDD slots or ROs) is guaranteed to occupy a defined percentage of the total transmission power. In some examples, this percentage may depend on the proportion of the one slot type within the total number of slots used for PRACH repetition. For example, if the one slot type or RO type (e.g., the TDD slots or ROs) accounts for 25% of the total slots or ROs, the corresponding percentage of the total transmission power allocated to the TDD ROs may be set to 60% of the total transmission power.

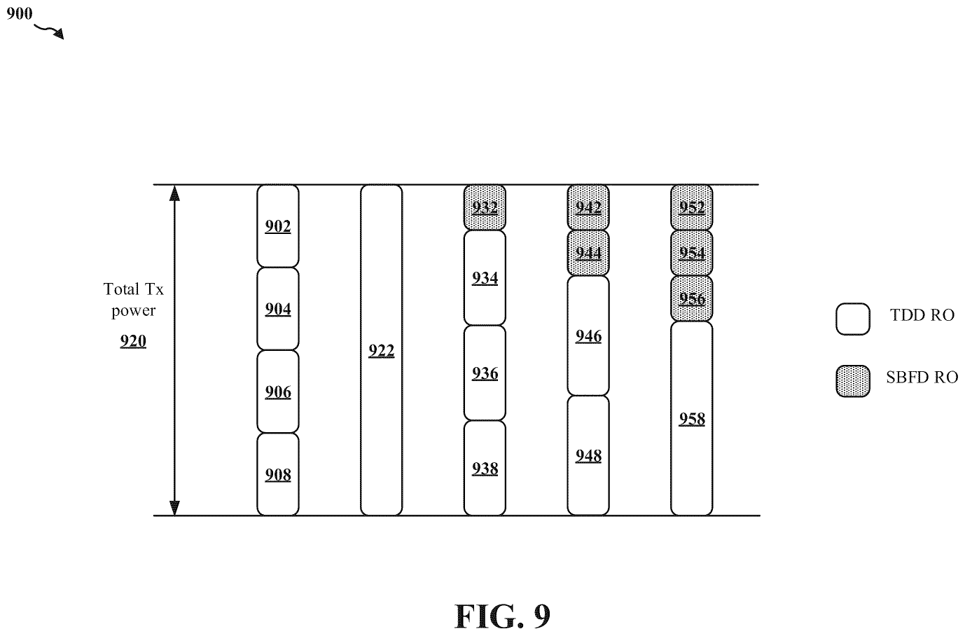

In some aspects, when redistributing the total transmission power across different RO type (or slot type), the total transmission power may be calculated assuming the same RO type. For example, the total transmission power may be calculated by assuming that all slots are TDD slots, and then the power is redistributed accordingly. FIG. 9 is a diagram 900 illustrating an example power control method in accordance with various aspects of the present disclosure. As shown in FIG. 9, when redistributing the total transmission power across different RO type, the total transmission power 920 may be calculated assuming the same RO type. For example, the UE may assume all the four ROs are TDD RO, and the total transmission power 920 (or transmission power 922) may be determined based on the transmission power for each of the TDD RO (e.g., transmission power 902, 904, 906, 908). The transmission power for different RO types may be determined based on the total transmission power 920. For example, when the combination of RO types includes three TDD ROs and one SBFD RO, the transmission powers of the three TDD ROs may be transmission power 934, 936, 938, while the transmission power for the SBFD RO may be transmission power 932. The sum of these transmission powers (e.g., transmission power 932, 934, 936, 938) may equal to the total transmission power 920. When the combination of RO types includes two TDD ROs and two SBFD ROs, the transmission powers of the two TDD ROs may be transmission power 946, 948, while the transmission powers of the two SBFD ROs may be transmission power 942, 944. The sum of these transmission powers (e.g., transmission power 942, 944, 946, 948) may equal to the total transmission power 920. When the combination of RO types includes one TDD RO and three SBFD ROs, the transmission power of the TDD RO may be transmission power 958, while the transmission powers of the three SBFD ROs may be transmission power 952, 954, 956. The sum of these transmission powers (e.g., transmission power 952, 954, 956, 958) may equal to the total transmission power 920.

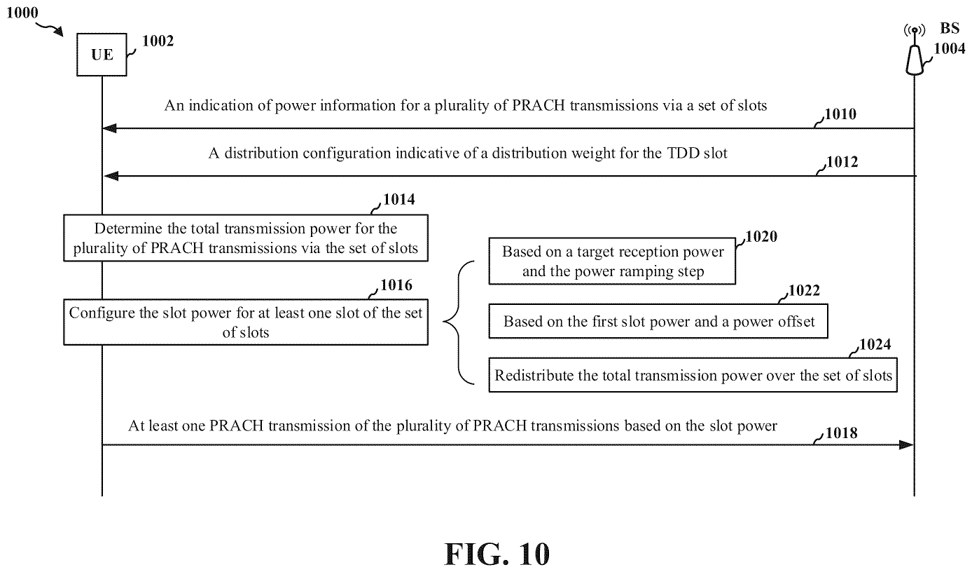

FIG. 10 is a call flow diagram 1000 illustrating a method of wireless communication in accordance with various aspects of this present disclosure. Various aspects are described in connection with a UE 1002 and a base station 1004. The aspects may be performed by the UE 1002 or the base station 1004 in aggregation and/or by one or more components of a base station 1004 (e.g., a CU 110, a DU 130, and/or an RU 140).

As shown in FIG. 10, at 1010, the UE 1002 may obtain (e.g., from base station 1004) an indication of power information for a plurality of PRACH transmissions via a set of slots. The power information may indicate the transmission power for each PRACH transmission of the plurality of PRACH transmissions. In some examples, the plurality of PRACH transmissions may include a plurality of PRACH repetitions on PRACH occasions located on the set of slots. For example, the PRACH occasions may be RO 512, 514, 516, 518.

At 1012, the UE 1002 may receive from base station 1004 a distribution configuration. The distribution configuration may indicate a distribution weight between different types of slots (e.g., TDD slots and SBFD slots) when distributing the transmission power for these different types of slots (e.g., at 1024). For example, referring to FIG. 8, the distribution configuration may indicate a distribution weight between transmission power 852 for a TDD RO and the transmission power 850 for an SBFD RO when distributing the total transmission power 822. In some examples, when distributing the transmission power for these different types of slots (e.g., at 1024), the ratio between the first power for one type of slot (e.g., TDD slot) and the total transmission power may be based on the distribution weight.

At 1014, the UE 1002 may determine the total transmission power for the plurality of PRACH transmissions via the set of slots. For example, the total transmission power may be determined based on the transmission power for each PRACH transmission of the plurality of PRACH transmissions. In some examples, the UE 1002 may determine the total transmission power by assuming that all slots are one type of slots (e.g., TDD slots). For example, referring to FIG. 8, the UE may determine the total transmission power 822 for the plurality of PRACH transmissions via the set of slots. Referring to FIG. 9, the UE may determine the total transmission power 920 by assuming that all slots are TDD slots.

At 1016, the UE 1002 may configure the slot power for at least one slot of the set of slots based on the transmission power for each PRACH transmission of the plurality of PRACH transmissions. The UE 1002 may configure the slot power for at least one slot of the set of slots in different ways. In some examples, the UE 1002 may configure the slot power for the at least one slot of the set of slots based on the target reception power (e.g., preambleReceivedTargetPower) and the power ramping step (e.g., PREAMBLE_POWER_RAMPING_STEP). In some examples, when configuring the slot power for at least one slot of the set of slots (e.g., at 1016), the UE 1002 may first configure the first slot power for one slot type (e.g., the slot power for one of the TDD slot or the SBFD slot), and slot power for the other slot type may be obtained based on the first slot power and a power offset between different slot types (e.g., at 1022). In some examples, at 1024, when configuring the slot power for at least one slot of the set of slots (e.g., at 1016), the UE 1002 may redistribute the total transmission power over the set of slots to obtain the slot power for the at least one slot of the set of slots (e.g., at 1024).

At 1018, the UE 1002 may transmit, via the at least one slot of the set of slots, at least one PRACH transmission of the plurality of PRACH transmissions to base station 1004 based on the slot power.

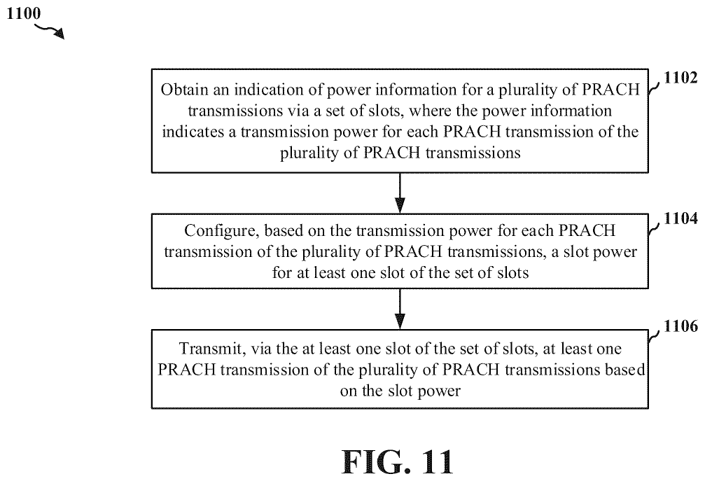

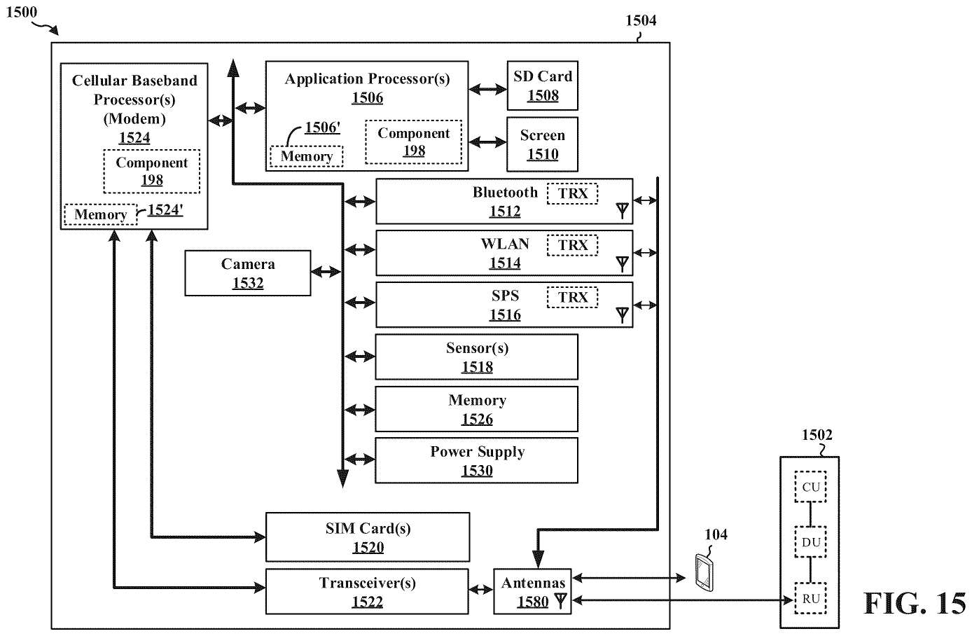

FIG. 11 is a flowchart 1100 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 1004; or the network entity 1502 in the hardware implementation of FIG. 15). The UE may be the UE 104, 350, 1002, or the apparatus 1504 in the hardware implementation of FIG. 15. By providing a unified power control mechanism for PRACH repetition transmission that accounts for the composition of slot types within a repetition, the methods improve random access performance and enhance resource utilization efficiency. Additionally, by determining PRACH transmission power based on whether the PRACH repetitions occur entirely on TDD slots, entirely on SBFD slots, or a combination of both, the methods enable power control strategies tailored to the specific slot composition, thereby avoiding over-powering or under-powering individual repetitions. In some examples, by calculating the total transmission power over all PRACH repetitions and redistributing it among the different slot types, the methods ensure consistent overall power output while optimizing power balance between slot types.

As shown in FIG. 11, at 1102, the UE may obtain an indication of power information for a plurality of PRACH transmissions via a set of slots. The power information may indicate the transmission power for each PRACH transmission of the plurality of PRACH transmissions. FIG. 7, FIG. 8, FIG. 9, and FIG. 10 illustrate various aspects of the steps in connection with flowchart 1100. For example, referring to FIG. 10, the UE 1002 may, at 1010, obtain an indication of power information for a plurality of PRACH transmissions via a set of slots. The power information may indicate the transmission power for each PRACH transmission of the plurality of PRACH transmissions. In some aspects, 1102 may be performed by the power control component 198.

At 1104, the UE may configure a slot power for at least one slot of the set of slots based on the transmission power for each PRACH transmission of the plurality of PRACH transmissions. For example, referring to FIG. 10, the UE 1002 may, at 1016, configure a slot power for at least one slot of the set of slots based on the transmission power for each PRACH transmission of the plurality of PRACH transmissions. In some aspects, 1104 may be performed by the power control component 198.

At 1106, the UE may transmit, via the at least one slot of the set of slots, at least one PRACH transmission of the plurality of PRACH transmissions based on the slot power. For example, referring to FIG. 10, the UE 1002 may, at 1018, transmit, via the at least one slot of the set of slots, at least one PRACH transmission of the plurality of PRACH transmissions based on the slot power. In some aspects, 1106 may be performed by the power control component 198.

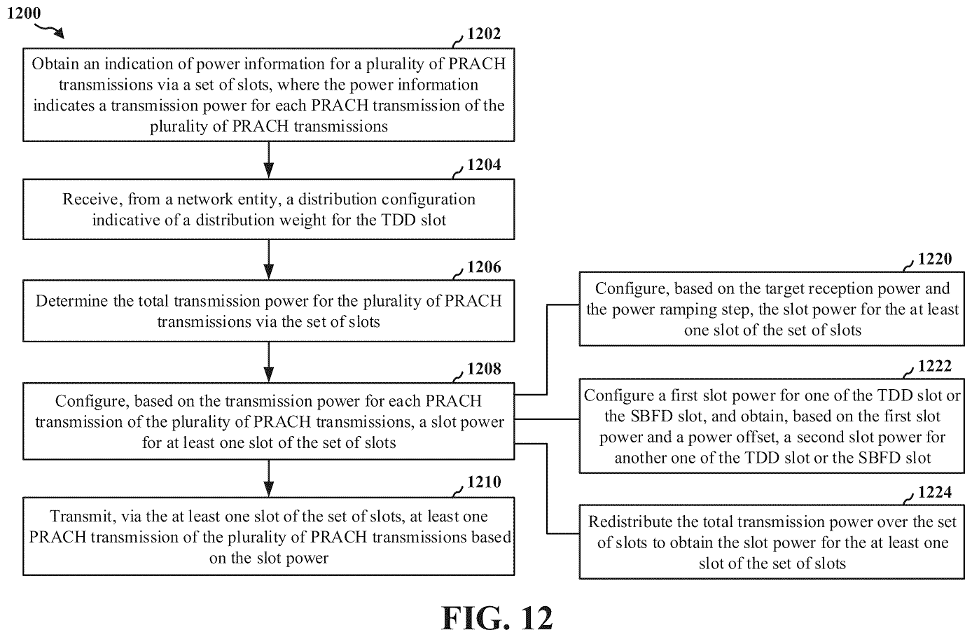

FIG. 12 is a flowchart 1200 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 1004; or the network entity 1502 in the hardware implementation of FIG. 15). The UE may be the UE 104, 350, 1002, or the apparatus 1504 in the hardware implementation of FIG. 15. By providing a unified power control mechanism for PRACH repetition transmission that accounts for the composition of slot types within a repetition, the methods improve random access performance and enhance resource utilization efficiency. Additionally, by determining PRACH transmission power based on whether the PRACH repetitions occur entirely on TDD slots, entirely on SBFD slots, or a combination of both, the methods enable power control strategies tailored to the specific slot composition, thereby avoiding over-powering or under-powering individual repetitions. In some examples, by calculating the total transmission power over all PRACH repetitions and redistributing it among the different slot types, the methods ensure consistent overall power output while optimizing power balance between slot types.

As shown in FIG. 12, at 1202, the UE may obtain an indication of power information for a plurality of PRACH transmissions via a set of slots. The power information may indicate the transmission power for each PRACH transmission of the plurality of PRACH transmissions. FIG. 7, FIG. 8, FIG. 9, and FIG. 10 illustrate various aspects of the steps in connection with flowchart 1200. For example, referring to FIG. 10, the UE 1002 may, at 1010, obtain an indication of power information for a plurality of PRACH transmissions via a set of slots. The power information may indicate the transmission power for each PRACH transmission of the plurality of PRACH transmissions. In some aspects, 1202 may be performed by the power control component 198.

At 1208, the UE may configure a slot power for at least one slot of the set of slots based on the transmission power for each PRACH transmission of the plurality of PRACH transmissions. For example, referring to FIG. 10, the UE 1002 may, at 1016, configure a slot power for at least one slot of the set of slots based on the transmission power for each PRACH transmission of the plurality of PRACH transmissions. In some aspects, 1208 may be performed by the power control component 198.

At 1210, the UE may transmit, via the at least one slot of the set of slots, at least one PRACH transmission of the plurality of PRACH transmissions based on the slot power. For example, referring to FIG. 10, the UE 1002 may, at 1018, transmit, via the at least one slot of the set of slots, at least one PRACH transmission of the plurality of PRACH transmissions based on the slot power. In some aspects, 1210 may be performed by the power control component 198.

In some aspects, the plurality of PRACH transmissions may include a plurality of PRACH repetitions on PRACH occasions located on the set of slots. For example, referring to FIG. 10, the plurality of PRACH transmissions (e.g., at 1010) may include a plurality of PRACH repetitions on PRACH occasions located on the set of slots. Referring to FIG. 5, the PRACH occasions may be RO 512, 514, 516, 518.

In some aspects, the set of slots may include a first set of TDD slots or a second set of SBFD slots. The power information may include a target reception power and a power ramping step. To configure the slot power for the at least one slot of the set of slots (e.g., at 1208), the UE may configure the slot power for the at least one slot of the set of slots based on the target reception power and the power ramping step (e.g., at 1220). For example, referring to FIG. 10, the set of slots (e.g., at 1010) may include a first set of TDD slots or a second set of SBFD slots. The power information may include a target reception power (e.g., preambleReceivedTargetPower) and a power ramping step (e.g., PREAMBLE_POWER_RAMPING_STEP). To configure the slot power for the at least one slot of the set of slots (e.g., at 1016), the UE 1002 may configure the slot power for the at least one slot of the set of slots based on the target reception power (e.g., preambleReceivedTargetPower) and the power ramping step (e.g., PREAMBLE_POWER_RAMPING_STEP) at 1020. In some aspects, 1220 may be performed by the power control component 198.

In some aspects, the set of slots may include at least one TDD slot and at least one SBFD slot. To configure the slot power for the at least one slot of the set of slots (e.g., at 1208), the UE may configure a first slot power for one of the TDD slot or the SBFD slot; and obtain, based on the first slot power and a power offset, a second slot power for another one of the TDD slot or the SBFD slot (e.g., at 1222). For example, referring to FIG. 10, the set of slots (e.g., at 1010) may include at least one TDD slot and at least one SBFD slot. To configure the slot power for the at least one slot of the set of slots (e.g., at 1016), the UE 1002 may configure a first slot power for one of the TDD slot or the SBFD slot and obtain, based on the first slot power and a power offset, a second slot power for another one of the TDD slot or the SBFD slot (e.g., at 1022). In some aspects, 1222 may be performed by the power control component 198.

In some aspects, the indication of the power information (e.g., at 1202) may include a semi-static configuration including power parameters for each combination of the TDD slot and the SBFD slot in the set of slots, and the UE may configure the first slot power for one of the TDD slot or the SBFD slot (e.g., at 1222) based on the power parameters for each combination of the TDD slot and the SBFD slot in the set of slots. For example, referring to FIG. 10, the indication of the power information (e.g., at 1010) may include a semi-static configuration including power parameters for each combination of the TDD slot and the SBFD slot in the set of slots. For example, referring to FIG. 7, the semi-static configuration may include power parameters for each combination of the TDD slot and the SBFD slot, such as the first combination of three TDD ROs and one SBFD RO in diagram 700, the second combination of two TDD ROs and two SBFD ROs in diagram 730, and the third combination of one TDD RO and three SBFD ROs in diagram 760.

In some aspects, the indication of the power information (e.g., at 1202) may include a semi-static configuration including a target reception power. The UE may configure the first slot power for one of the TDD slot or the SBFD slot (e.g., at 1222) based on the target reception power and a type offset. The type offset may be based on the number of SBFD slots in the set of slots. For example, referring to FIG. 10, the indication of the power information (e.g., at 1010) may include a semi-static configuration including a target reception power. The UE 1002 may configure the first slot power for one of the TDD slot or the SBFD slot (e.g., at 1016) based on the target reception power and a type offset. For example, in FIG. 7, the offset for one SBFD RO (e.g., in diagram 700), two SBFD ROs (e.g., in diagram 730), and three SBFD ROs (e.g., in diagram 760) may each have distinct values, which may differ from one another. In some examples, the offset values for different numbers of SBFD ROs may not be linear with respect to the number of SBFD ROs.

In some aspects, at 1206, the UE may determine the total transmission power for the plurality of PRACH transmissions via the set of slots based on the transmission power for each PRACH transmission of the plurality of PRACH transmissions. The UE may configure the slot power for the at least one slot of the set of slots by redistributing the total transmission power over the set of slots to obtain the slot power for the at least one slot of the set of slots (e.g., at 1224). For example, referring to FIG. 10, the UE 1002 may, at 1014, determine the total transmission power for the plurality of PRACH transmissions via the set of slots based on the transmission power for each PRACH transmission of the plurality of PRACH transmissions. The UE 1002 may configure the slot power for the at least one slot of the set of slots by redistributing the total transmission power over the set of slots to obtain the slot power for the at least one slot of the set of slots (e.g., at 1024). In some aspects, 1206 and 1224 may be performed by the power control component 198.

In some aspects, when redistributing the total transmission power over the set of slots (e.g., at 1224), the UE may redistribute the total transmission power equally across each of the set of slots. For example, referring to FIG. 8, in diagram 820, the UE may redistribute the total transmission power 822 equally across each of the set of slots with transmission power 840, 842, 844, 846. In diagram 860, the UE may redistribute the total transmission power 862 equally across each of the set of slots with transmission power 880, 882, 884, 886.

In some aspects, the set of slots may include at least one TDD slot and at least one SBFD slot. When redistributing the total transmission power over the set of slots (e.g., at 1224), the UE may allocate a first power from the total transmission power for each TDD slot in the set of slots; and allocate a second power from the total transmission power for each SBFD slot in the set of slots. For example, referring to FIG. 8, in diagram 820, the UE may allocate a first power (e.g., transmission power 802) from the total transmission power 822 for each TDD slot in the set of slots; and allocate a second power (e.g., transmission power 804) from the total transmission power 822 for each SBFD slot in the set of slots.

In some aspects, the first power is greater than the second power. For example, referring to FIG. 8, the first transmission power 802 is greater than the second transmission power 804.

In some aspects, at 1204, the UE may receive, from the network entity, a distribution configuration indicative of a distribution weight for the TDD slot. The ratio between the first power and the total transmission power may be based on the distribution weight. For example, referring to FIG. 10, the UE 1002 may, at 1012, receive, from the network entity (base station 1004), a distribution configuration indicative of a distribution weight for the TDD slot. The ratio between the first power and the total transmission power may be based on the distribution weight.

In some aspects, the aggregated power for the TDD slots may be greater than or equal to a threshold percentage of the total transmission power. For example, referring to FIG. 8, in diagram 860, the aggregated power for the TDD slots (e.g., the aggregation of transmission power 874, 876) may be greater than or equal to a threshold percentage of the total transmission power 862.

In some aspects, the UE may determine the total transmission power for the plurality of PRACH transmissions via the set of slots based on the transmission power for transmission of the PRACH transmission on a first type of slot in the set of slots. For example, referring to FIG. 9 and FIG. 10, the UE 1002 may, at 1014, determine the total transmission power for the plurality of PRACH transmissions via the set of slots based on the transmission power for transmission of the PRACH transmission on a first type of slot in the set of slots (e.g., the transmission power 902 for TDD RO).

In some aspects, the first type of slot may include a TDD slot. For example, referring to FIG. 7, the first type of slot may include a TDD slot (e.g., TDD RO 702, 704, 706).

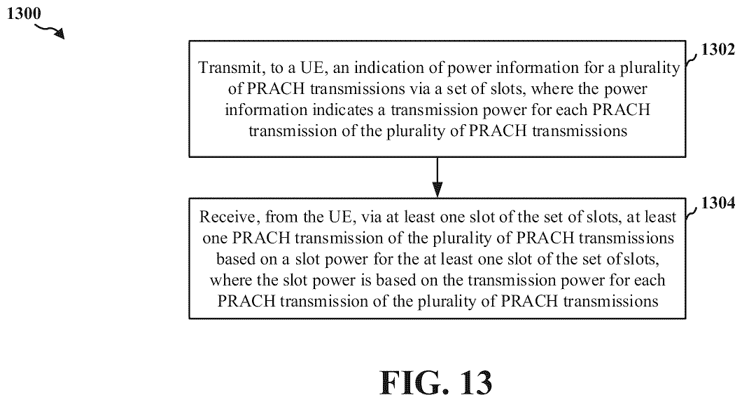

FIG. 13 is a flowchart 1300 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 1004; or the network entity 1502 in the hardware implementation of FIG. 15). The UE may be the UE 104, 350, 1002, or the apparatus 1504 in the hardware implementation of FIG. 15. By providing a unified power control mechanism for PRACH repetition transmission that accounts for the composition of slot types within a repetition, the methods improve random access performance and enhance resource utilization efficiency. Additionally, by determining PRACH transmission power based on whether the PRACH repetitions occur entirely on TDD slots, entirely on SBFD slots, or a combination of both, the methods enable power control strategies tailored to the specific slot composition, thereby avoiding over-powering or under-powering individual repetitions. In some examples, by calculating the total transmission power over all PRACH repetitions and redistributing it among the different slot types, the methods ensure consistent overall power output while optimizing power balance between slot types.

As shown in FIG. 13, at 1302, the network entity may transmit, to a UE, an indication of power information for a plurality of PRACH transmissions via a set of slots. The power information may indicate the transmission power for each PRACH transmission of the plurality of PRACH transmissions. FIG. 7, FIG. 8, FIG. 9, and FIG. 10 illustrate various aspects of the steps in connection with flowchart 1300. For example, referring to FIG. 10, the network entity (e.g., base station 1004) may, at 1010, transmit, to a UE 1002, an indication of power information for a plurality of PRACH transmissions via a set of slots. The power information may indicate the transmission power for each PRACH transmission of the plurality of PRACH transmissions. In some aspects, 1302 may be performed by the power control component 199.

At 1304, the network entity may receive, from the UE, via at least one slot of the set of slots, at least one PRACH transmission of the plurality of PRACH transmissions based on a slot power for the at least one slot of the set of slots. The slot power may be based on the transmission power for each PRACH transmission of the plurality of PRACH transmissions. For example, referring to FIG. 10, the network entity (e.g., base station 1004) may, at 1018, receive, from the UE 1002, via at least one slot of the set of slots, at least one PRACH transmission of the plurality of PRACH transmissions based on a slot power for the at least one slot of the set of slots. The slot power may be based on the transmission power for each PRACH transmission of the plurality of PRACH transmissions. In some aspects, 1304 may be performed by the power control component 199.

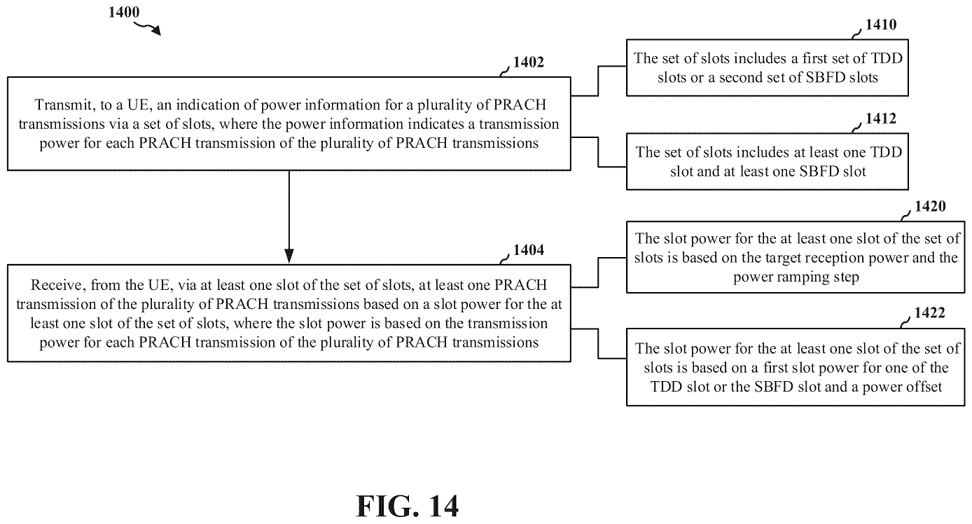

FIG. 14 is a flowchart 1400 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 1004; or the network entity 1502 in the hardware implementation of FIG. 15). The UE may be the UE 104, 350, 1002, or the apparatus 1504 in the hardware implementation of FIG. 15. By providing a unified power control mechanism for PRACH repetition transmission that accounts for the composition of slot types within a repetition, the methods improve random access performance and enhance resource utilization efficiency. Additionally, by determining PRACH transmission power based on whether the PRACH repetitions occur entirely on TDD slots, entirely on SBFD slots, or a combination of both, the methods enable power control strategies tailored to the specific slot composition, thereby avoiding over-powering or under-powering individual repetitions. In some examples, by calculating the total transmission power over all PRACH repetitions and redistributing it among the different slot types, the methods ensure consistent overall power output while optimizing power balance between slot types.

As shown in FIG. 14, at 1402, the network entity may transmit, to a UE, an indication of power information for a plurality of PRACH transmissions via a set of slots. The power information may indicate the transmission power for each PRACH transmission of the plurality of PRACH transmissions. FIG. 7, FIG. 8, FIG. 9, and FIG. 10 illustrate various aspects of the steps in connection with flowchart 1400. For example, referring to FIG. 10, the network entity (e.g., base station 1004) may, at 1010, transmit, to a UE 1002, an indication of power information for a plurality of PRACH transmissions via a set of slots. The power information may indicate the transmission power for each PRACH transmission of the plurality of PRACH transmissions. In some aspects, 1402 may be performed by the power control component 199.

At 1404, the network entity may receive, from the UE, via at least one slot of the set of slots, at least one PRACH transmission of the plurality of PRACH transmissions based on a slot power for the at least one slot of the set of slots. The slot power may be based on the transmission power for each PRACH transmission of the plurality of PRACH transmissions. For example, referring to FIG. 10, the network entity (e.g., base station 1004) may, at 1018, receive, from the UE 1002, via at least one slot of the set of slots, at least one PRACH transmission of the plurality of PRACH transmissions based on a slot power for the at least one slot of the set of slots. The slot power may be based on the transmission power for each PRACH transmission of the plurality of PRACH transmissions. In some aspects, 1404 may be performed by the power control component 199.

In some aspects, the plurality of PRACH transmissions may include a plurality of PRACH repetitions on PRACH occasions located on the set of slots. For example, referring to FIG. 10, the plurality of PRACH transmissions (e.g., at 1010) may include a plurality of PRACH repetitions on PRACH occasions located on the set of slots. Referring to FIG. 5, the PRACH occasions may be RO 512, 514, 516, 518.

In some aspects, the set of slots may include a first set of TDD slots or a second set of SBFD slots (e.g., at 1410), and the power information may include a target reception power and a power ramping step. The slot power for the at least one slot of the set of slots may be based on the target reception power and the power ramping step (e.g., at 1420). For example, referring to FIG. 10, the set of slots (e.g., at 1010) may include a first set of TDD slots or a second set of SBFD slots. The power information may include a target reception power (e.g., preambleReceivedTargetPower) and a power ramping step (e.g., PREAMBLE_POWER_RAMPING_STEP). The slot power for the at least one slot of the set of slots is based on the target reception power (e.g., preambleReceivedTargetPower) and the power ramping step (e.g., PREAMBLE_POWER_RAMPING_STEP) at 1020.

In some aspects, the set of slots may include at least one TDD slot and at least one SBFD slot (e.g., at 1412), and the slot power for the at least one slot of the set of slots may be based on a first slot power for one of the TDD slot or the SBFD slot and a power offset (e.g., at 1422). For example, referring to FIG. 10, the set of slots (e.g., at 1010) may include at least one TDD slot and at least one SBFD slot. The slot power for the at least one slot of the set of slots is based on the first slot power and a power offset (e.g., at 1022).

In some aspects, the indication of the power information may include a semi-static configuration including power parameters for each combination of the TDD slot and the SBFD slot in the set of slots, and the first slot power for one of the TDD slot or the SBFD slot may be based on the power parameters for each combination of the TDD slot and the SBFD slot in the set of slots. For example, referring to FIG. 10, the indication of the power information (e.g., at 1010) may include a semi-static configuration including power parameters for each combination of the TDD slot and the SBFD slot in the set of slots. For example, referring to FIG. 7, the semi-static configuration may include power parameters for each combination of the TDD slot and the SBFD slot, such as the first combination of three TDD ROs and one SBFD RO in diagram 700, the second combination of two TDD ROs and two SBFD ROs in diagram 730, and the third combination of one TDD RO and three SBFD ROs in diagram 760.

In some aspects, the indication of the power information may include a semi-static configuration including a target reception power. The first slot power for one of the TDD slot or the SBFD slot may be based on the target reception power and a type offset, and the type offset may be based on the number of SBFD slots in the set of slots. For example, referring to FIG. 10, the indication of the power information (e.g., at 1010) may include a semi-static configuration including a target reception power. The UE 1002 may configure the first slot power for one of the TDD slot or the SBFD slot (e.g., at 1016) based on the target reception power and a type offset. For example, in FIG. 7, the offset for one SBFD RO (e.g., in diagram 700), two SBFD ROs (e.g., in diagram 730), and three SBFD ROs (e.g., in diagram 760) may each have distinct values, which may differ from one another. In some examples, the offset values for different numbers of SBFD ROs may not be linear with respect to the number of SBFD ROS.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor (or processing circuitry) 1524 (also referred to as a modem) coupled to one or more transceivers 1522 (e.g., cellular RF transceiver). The cellular baseband processor(s) (or processing circuitry) 1524 may include at least one on-chip memory (or memory circuitry) 1524′. In some aspects, the apparatus 1504 may further include one or more subscriber identity modules (SIM) cards 1520 and at least one application processor (or processing circuitry) 1506 coupled to a secure digital (SD) card 1508 and a screen 1510. The application processor(s) (or processing circuitry) 1506 may include on-chip memory (or memory circuitry) 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) (or processing circuitry) 1524 communicates through the transceiver(s) 1522 via one or more antennas 1580 with the UE 104 and/or with an RU associated with a network entity 1502. The cellular baseband processor(s) (or processing circuitry) 1524 and the application processor(s) (or processing circuitry) 1506 may each include a computer-readable medium/memory (or memory circuitry) 1524′, 1506′, respectively. The additional memory modules 1526 may also be considered a computer-readable medium/memory (or memory circuitry). Each computer-readable medium/memory (or memory circuitry) 1524′, 1506′, 1526 may be non-transitory. The cellular baseband processor(s) (or processing circuitry) 1524 and the application processor(s) (or processing circuitry) 1506 are each responsible for general processing, including the execution of software stored on the computer-readable medium/memory (or memory circuitry). The software, when executed by the cellular baseband processor(s) (or processing circuitry) 1524/application processor(s) (or processing circuitry) 1506, causes the cellular baseband processor(s) (or processing circuitry) 1524/application processor(s) (or processing circuitry) 1506 to perform the various functions described supra. The cellular baseband processor(s) (or processing circuitry) 1524 and the application processor(s) (or processing circuitry) 1506 are configured to perform the various functions described supra based at least in part of the information stored in the memory (or memory circuitry). That is, the cellular baseband processor(s) (or processing circuitry) 1524 and the application processor(s) (or processing circuitry) 1506 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1524/application processor(s) (or processing circuitry) 1506 when executing software. The cellular baseband processor(s) (or processing circuitry) 1524/application processor(s) (or processing circuitry) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) (or processing circuitry) 1524 and/or the application processor(s) (or processing circuitry) 1506, and in another configuration, the apparatus 1504 may be the entire UE (e.g., see UE 350 of FIG. 3) and include the additional modules of the apparatus 1504.

As discussed supra, the component 198 may be configured to obtain an indication of power information for a plurality of PRACH transmissions via a set of slots, where the power information indicates a transmission power for each PRACH transmission of the plurality of PRACH transmissions; configure, based on the transmission power for each PRACH transmission of the plurality of PRACH transmissions, a slot power for at least one slot of the set of slots; and transmit, via the at least one slot of the set of slots, at least one PRACH transmission of the plurality of PRACH transmissions based on the slot power. The component 198 may be further configured to perform any of the aspects described in connection with the flowcharts in FIG. 11 and FIG. 12, and/or performed by the UE 1002 in FIG. 10. The component 198 may be within the cellular baseband processor(s) (or processing circuitry) 1524, the application processor(s) (or processing circuitry) 1506, or both the cellular baseband processor(s) (or processing circuitry) 1524 and the application processor(s) (or processing circuitry) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) (or processing circuitry) 1524 and/or the application processor(s) (or processing circuitry) 1506, includes means for obtaining an indication of power information for a plurality of PRACH transmissions via a set of slots, where the power information indicates a transmission power for each PRACH transmission of the plurality of PRACH transmissions; means for configuring, based on the transmission power for each PRACH transmission of the plurality of PRACH transmissions, a slot power for at least one slot of the set of slots; and means for transmitting, via the at least one slot of the set of slots, at least one PRACH transmission of the plurality of PRACH transmissions based on the slot power. The apparatus 1504 may further include means for performing any of the aspects described in connection with the flowcharts in FIG. 11 and FIG. 12, and/or aspects performed by the UE 1002 in FIG. 10. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

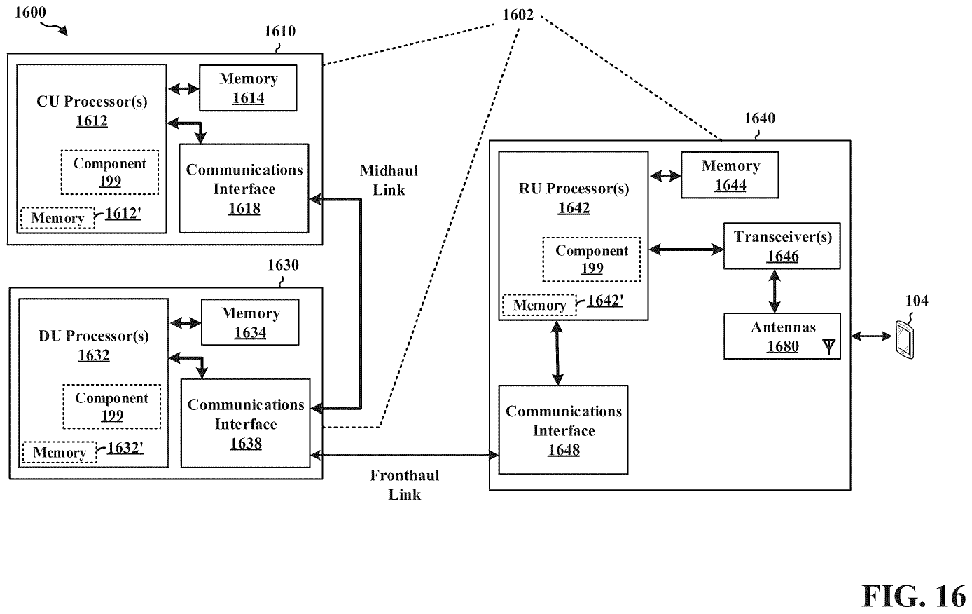

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor (or processing circuitry) 1612. The CU processor(s) (or processing circuitry) 1612 may include on-chip memory (or memory circuitry) 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor (or processing circuitry) 1632. The DU processor(s) (or processing circuitry) 1632 may include on-chip memory (or memory circuitry) 1632′. In some aspects, the DU 1630 may further include additional memory modules 1634 and a communications interface 1638. The DU 1630 communicates with the RU 1640 through a fronthaul link. The RU 1640 may include at least one RU processor (or processing circuitry) 1642. The RU processor(s) (or processing circuitry) 1642 may include on-chip memory (or memory circuitry) 1642′. In some aspects, the RU 1640 may further include additional memory modules 1644, one or more transceivers 1646, antennas 1680, and a communications interface 1648.

The RU 1640 communicates with the UE 104. The on-chip memory (or memory circuitry) 1612′, 1632′, 1642′ and the additional memory modules 1614, 1634, 1644 may each be considered a computer-readable medium/memory (or memory circuitry). Each computer-readable medium/memory (or memory circuitry) may be non-transitory. Each of the processors (or processing circuitry) 1612, 1632, 1642 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, to a UE, an indication of power information for a plurality of PRACH transmissions via a set of slots, where the power information indicates a transmission power for each PRACH transmission of the plurality of PRACH transmissions; and receive, from the UE, via at least one slot of the set of slots, at least one PRACH transmission of the plurality of PRACH transmissions based on a slot power for the at least one slot of the set of slots, where the slot power is based on the transmission power for each PRACH transmission of the plurality of PRACH transmissions. The component 199 may be further configured to perform any of the aspects described in connection with the flowcharts in FIG. 13 and FIG. 14, and/or performed by the base station 1004 in FIG. 10. The component 199 may be within one or more processors (or processing circuitry) of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 includes means for transmitting, to a UE, an indication of power information for a plurality of PRACH transmissions via a set of slots, where the power information indicates a transmission power for each PRACH transmission of the plurality of PRACH transmissions; and means for receiving, from the UE, via at least one slot of the set of slots, at least one PRACH transmission of the plurality of PRACH transmissions based on a slot power for the at least one slot of the set of slots, where the slot power is based on the transmission power for each PRACH transmission of the plurality of PRACH transmissions. The network entity 1602 may further include means for performing any of the aspects described in connection with the flowcharts in FIG. 13 and FIG. 14, and/or aspects performed by the base station 1004 in FIG. 10. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include obtaining an indication of power information for a plurality of PRACH transmissions via a set of slots, where the power information indicates a transmission power for each PRACH transmission of the plurality of PRACH transmissions; configuring, based on the transmission power for each PRACH transmission of the plurality of PRACH transmissions, a slot power for at least one slot of the set of slots; and transmitting, via the at least one slot of the set of slots, at least one PRACH transmission of the plurality of PRACH transmissions based on the slot power. By providing a unified power control mechanism for PRACH repetition transmission that accounts for the composition of slot types within a repetition, the methods improve random access performance and enhance resource utilization efficiency. Additionally, by determining PRACH transmission power based on whether the PRACH repetitions occur entirely on TDD slots, entirely on SBFD slots, or a combination of both, the methods enable power control strategies tailored to the specific slot composition, thereby avoiding over-powering or under-powering individual repetitions. In some examples, by calculating the total transmission power over all PRACH repetitions and redistributing it among the different slot types, the methods ensure consistent overall power output while optimizing power balance between slot types.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE). The method includes obtaining an indication of power information for a plurality of physical random access channel (PRACH) transmissions via a set of slots, wherein the power information indicates a transmission power for each PRACH transmission of the plurality of PRACH transmissions; configuring, based on the transmission power for each PRACH transmission of the plurality of PRACH transmissions, a slot power for at least one slot of the set of slots; and transmitting, via the at least one slot of the set of slots, at least one PRACH transmission of the plurality of PRACH transmissions based on the slot power.

Aspect 2 is the method of aspect 1, wherein the plurality of PRACH transmissions includes a plurality of PRACH repetitions on PRACH occasions located on the set of slots.

Aspect 3 is the method of any of aspects 1 to 2, wherein the set of slots includes a first set of time division duplexing (TDD) slots or a second set of subband full-duplex (SBFD) slots, and wherein the power information includes a target reception power and a power ramping step, and wherein configuring the slot power for the at least one slot of the set of slots comprises configuring, based on the target reception power and the power ramping step, the slot power for the at least one slot of the set of slots.

Aspect 4 is the method of any of aspects 1 to 2, wherein the set of slots includes at least one time division duplexing (TDD) slot and at least one subband full-duplex (SBFD) slot, and wherein configuring the slot power for the at least one slot of the set of slots comprises configuring a first slot power for one of the at least one TDD slot or the at least one SBFD slot; and obtaining, based on the first slot power and a power offset, a second slot power for another one of the at least one TDD slot or the at least one SBFD slot.

Aspect 5 is the method of aspect 4, wherein the indication of the power information includes a semi-static configuration comprising power parameters for each combination of the at least one TDD slot and the at least one SBFD slot in the set of slots, and wherein configuring the first slot power for one of the at least one TDD slot or the at least one SBFD slot comprises configuring, based on the power parameters for each combination of the at least one TDD slot and the at least one SBFD slot in the set of slots, the first slot power for one of the at least one TDD slot or the at least one SBFD slot.

Aspect 6 is the method of aspect 4, wherein the indication of the power information includes a semi-static configuration comprising a target reception power, wherein configuring the first slot power for one of the at least one TDD slot or the at least one SBFD slot comprises configuring, based on the target reception power and a type offset, the first slot power for one of the at least one TDD slot or the at least one SBFD slot, wherein the type offset is based on a number of SBFD slots in the set of slots.

Aspect 7 is the method of any of aspects 1 to 2, where the method further comprises determining, based on the transmission power for each PRACH transmission of the plurality of PRACH transmissions, a total transmission power for the plurality of PRACH transmissions via the set of slots, wherein configuring the slot power for the at least one slot of the set of slots comprises redistributing the total transmission power over the set of slots to obtain the slot power for the at least one slot of the set of slots.

Aspect 8 is the method of aspect 7, wherein redistributing the total transmission power over the set of slots comprises redistributing the total transmission power equally across each of the set of slots.

Aspect 9 is the method of aspect 7, wherein the set of slots includes at least one time division duplexing (TDD) slot and at least one subband full-duplex (SBFD) slot, and wherein redistributing the total transmission power over the set of slots comprises allocating a first power from the total transmission power for each TDD slot in the set of slots; and allocating a second power from the total transmission power for each SBFD slot in the set of slots.

Aspect 10 is the method of aspect 9, wherein the first power is greater than the second power.

Aspect 11 is the method of aspect 9, where the method further comprises receiving, from a network entity, a distribution configuration indicative of a distribution weight for the at least one TDD slot, and wherein a ratio between the first power and the total transmission power is based on the distribution weight.

Aspect 12 is the method of aspect 9, wherein an aggregated power for the at least one TDD slot is greater than or equal to a threshold percentage of the total transmission power.

Aspect 13 is the method of aspect 7, wherein determining the total transmission power for the plurality of PRACH transmissions via the set of slots comprises determining the total transmission power based on the transmission power for transmission of each PRACH transmission on a first type of slot in the set of slots.

Aspect 14 is the method of aspect 13, wherein the first type of slot includes a time division duplexing (TDD) slot.

Aspect 15 is an apparatus for wireless communication at a UE, comprising: at least one memory; and at least one processor coupled to the at least one memory, the at least one processor is configured to perform the method of any of aspects 1 to 14.

Aspect 16 is the apparatus for wireless communication at a UE, comprising means for performing each step in the method of any of aspects 1-14.

Aspect 17 is an apparatus of any of aspects 15-16, further comprising a transceiver configured to receive or to transmit in association with the method of any of aspects 1-14.

Aspect 18 is a computer-readable medium (e.g., a non-transitory computer-readable medium) storing computer executable code at a UE, the code when executed by at least one processor causes the at least one processor to perform the method of any of aspects 1-14.

Aspect 19 is a method of wireless communication at a network entity. The method includes transmitting, to a user equipment (UE), an indication of power information for a plurality of physical random access channel (PRACH) transmissions via a set of slots, wherein the power information indicates a transmission power for each PRACH transmission of the plurality of PRACH transmissions; and receiving, from the UE, via at least one slot of the set of slots, at least one PRACH transmission of the plurality of PRACH transmissions based on a slot power for the at least one slot of the set of slots, wherein the slot power is based on the transmission power for each PRACH transmission of the plurality of PRACH transmissions.

Aspect 20 is the method of aspect 19, wherein the plurality of PRACH transmissions includes a plurality of PRACH repetitions on PRACH occasions located on the set of slots.

Aspect 21 is the method of any of aspects 19 to 20, wherein the set of slots includes a first set of time division duplexing (TDD) slots or a second set of subband full-duplex (SBFD) slots, and wherein the power information includes a target reception power and a power ramping step, and wherein the slot power for the at least one slot of the set of slots is based on the target reception power and the power ramping step.

Aspect 22 is the method of any of aspects 19 to 20, wherein the set of slots includes at least one time division duplexing (TDD) slot and at least one subband full-duplex (SBFD) slot, and wherein the slot power for the at least one slot of the set of slots is based on a first slot power for one of the at least one TDD slot or the at least one SBFD slot and a power offset.

Aspect 23 is the method of aspect 22, wherein the indication of the power information includes a semi-static configuration comprising power parameters for each combination of the at least one TDD slot and the at least one SBFD slot in the set of slots, and wherein the first slot power for one of the at least one TDD slot or the at least one SBFD slot is based on the power parameters for each combination of the at least one TDD slot and the at least one SBFD slot in the set of slots.

Aspect 24 is the method of aspect 22, wherein the indication of the power information includes a semi-static configuration comprising a target reception power, wherein the first slot power for one of the TDD slot or the SBFD slot is based on the target reception power and a type offset, and wherein the type offset is based on a number of SBFD slots in the set of slots.

Aspect 25 is an apparatus for wireless communication at a network entity, comprising: at least one memory; and at least one processor coupled to the at least one memory and, where the at least one processor is configured to perform the method of any of aspects 19-24.

Aspect 26 is the apparatus for wireless communication at a network entity, comprising means for performing each step in the method of any of aspects 19-24.

Aspect 27 is an apparatus of any of aspects 25-26, further comprising a transceiver configured to receive or to transmit in association with the method of any of aspects 19-24.

Aspect 28 is a computer-readable medium (e.g., a non-transitory computer-readable medium) storing computer executable code at a network entity, the code when executed by at least one processor causes the at least one processor to perform the method of any of aspects 19-24.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
obtain an indication of power information for a plurality of physical random access channel (PRACH) transmissions via a set of slots, wherein the power information indicates a transmission power for each PRACH transmission of the plurality of PRACH transmissions;
configure, based on the transmission power for each PRACH transmission of the plurality of PRACH transmissions, a slot power for at least one slot of the set of slots; and
transmit, via the at least one slot of the set of slots, at least one PRACH transmission of the plurality of PRACH transmissions based on the slot power.

2. The apparatus of claim 1, further comprising a transceiver coupled to the at least one processor, wherein to transmit the at least one PRACH transmission of the plurality of PRACH transmissions, the at least one processor is configured to transmit the at least one PRACH transmission of the plurality of PRACH transmissions via the transceiver, and wherein the plurality of PRACH transmissions includes a plurality of PRACH repetitions on PRACH occasions located on the set of slots.

3. The apparatus of claim 2, wherein the set of slots includes a first set of time division duplexing (TDD) slots or a second set of subband full-duplex (SBFD) slots, and wherein the power information includes a target reception power and a power ramping step, and wherein to configure the slot power for the at least one slot of the set of slots, the at least one processor is configured to:
configure, based on the target reception power and the power ramping step, the slot power for the at least one slot of the set of slots.

4. The apparatus of claim 2, wherein the set of slots includes at least one time division duplexing (TDD) slot and at least one subband full-duplex (SBFD) slot, and wherein to configure the slot power for the at least one slot of the set of slots, the at least one processor is configured to:
configure a first slot power for one of the at least one TDD slot or the at least one SBFD slot; and
obtain, based on the first slot power and a power offset, a second slot power for another one of the at least one TDD slot or the at least one SBFD slot.

5. The apparatus of claim 4, wherein the indication of the power information includes a semi-static configuration comprising power parameters for each combination of the at least one TDD slot and the at least one SBFD slot in the set of slots, and wherein to configure the first slot power for one of the at least one TDD slot or the at least one SBFD slot, the at least one processor is configured to:
configure, based on the power parameters for each combination of the at least one TDD slot and the at least one SBFD slot in the set of slots, the first slot power for one of the at least one TDD slot or the at least one SBFD slot.

6. The apparatus of claim 4, wherein the indication of the power information includes a semi-static configuration comprising a target reception power, wherein to configure the first slot power for one of the at least one TDD slot or the at least one SBFD slot, the at least one processor is configured to:
configure, based on the target reception power and a type offset, the first slot power for one of the at least one TDD slot or the at least one SBFD slot, wherein the type offset is based on a number of SBFD slots in the set of slots.

7. The apparatus of claim 2, wherein the at least one processor is further configured to:
determine, based on the transmission power for each PRACH transmission of the plurality of PRACH transmissions, a total transmission power for the plurality of PRACH transmissions via the set of slots, wherein to configure the slot power for the at least one slot of the set of slots, the at least one processor is configured to:
redistribute the total transmission power over the set of slots to obtain the slot power for the at least one slot of the set of slots.

8. The apparatus of claim 7, wherein to redistribute the total transmission power over the set of slots, the at least one processor is configured to:
redistribute the total transmission power equally across each of the set of slots.

9. The apparatus of claim 7, wherein the set of slots includes at least one time division duplexing (TDD) slot and at least one subband full-duplex (SBFD) slot, and wherein to redistribute the total transmission power over the set of slots, the at least one processor is configured to:
allocate a first power from the total transmission power for each TDD slot in the set of slots; and
allocate a second power from the total transmission power for each SBFD slot in the set of slots.

10. The apparatus of claim 9, wherein the first power is greater than the second power.

11. The apparatus of claim 9, wherein the at least one processor is further configured to:
receive, from a network entity, a distribution configuration indicative of a distribution weight for the at least one TDD slot, and wherein a ratio between the first power and the total transmission power is based on the distribution weight.

12. The apparatus of claim 9, wherein an aggregated power for the at least one TDD slot is greater than or equal to a threshold percentage of the total transmission power.

13. The apparatus of claim 7, wherein to determine the total transmission power for the plurality of PRACH transmissions via the set of slots, the at least one processor is configured to:
determine the total transmission power based on the transmission power for transmission of each PRACH transmission on a first type of slot in the set of slots.

14. The apparatus of claim 13, wherein the first type of slot includes a time division duplexing (TDD) slot.

15. An apparatus for wireless communication at a network entity, comprising:
at least one memory; and
at least one processor coupled to the at least one memory and, based at least in part on information stored in the at least one memory, the at least one processor is configured to:
transmit, to a user equipment (UE), an indication of power information for a plurality of physical random access channel (PRACH) transmissions via a set of slots, wherein the power information indicates a transmission power for each PRACH transmission of the plurality of PRACH transmissions; and
receive, from the UE, via at least one slot of the set of slots, at least one PRACH transmission of the plurality of PRACH transmissions based on a slot power for the at least one slot of the set of slots, wherein the slot power is based on the transmission power for each PRACH transmission of the plurality of PRACH transmissions.

16. The apparatus of claim 15, further comprising a transceiver coupled to the at least one processor, wherein to receive the at least one PRACH transmission of the plurality of PRACH transmissions, the at least one processor is configured to receive the at least one PRACH transmission of the plurality of PRACH transmissions via the transceiver, and wherein the plurality of PRACH transmissions includes a plurality of PRACH repetitions on PRACH occasions located on the set of slots.

17. The apparatus of claim 16, wherein the set of slots includes a first set of time division duplexing (TDD) slots or a second set of subband full-duplex (SBFD) slots, and wherein the power information includes a target reception power and a power ramping step, and wherein the slot power for the at least one slot of the set of slots is based on the target reception power and the power ramping step.

18. The apparatus of claim 16, wherein the set of slots includes at least one time division duplexing (TDD) slot and at least one subband full-duplex (SBFD) slot, and wherein the slot power for the at least one slot of the set of slots is based on a first slot power for one of the at least one TDD slot or the at least one SBFD slot and a power offset.

19. The apparatus of claim 18, wherein the indication of the power information includes a semi-static configuration comprising power parameters for each combination of the at least one TDD slot and the at least one SBFD slot in the set of slots, and wherein the first slot power for one of the at least one TDD slot or the at least one SBFD slot is based on the power parameters for each combination of the at least one TDD slot and the at least one SBFD slot in the set of slots.

20. A method of wireless communication at a user equipment (UE), comprising:
obtaining an indication of power information for a plurality of physical random access channel (PRACH) transmissions via a set of slots, wherein the power information indicates a transmission power for each PRACH transmission of the plurality of PRACH transmissions;
configuring, based on the transmission power for each PRACH transmission of the plurality of PRACH transmissions, a slot power for at least one slot of the set of slots; and
transmitting, via the at least one slot of the set of slots, at least one PRACH transmission of the plurality of PRACH transmissions based on the slot power.
